(19) United States
(12) Patent Application Publication
(10) Pub. No.: US 2026/0176460 A1
(43) Pub. Date: Jun. 25, 2026

(54) PAVING AND ROOFING COMPOSITE MATERIAL COMPRISING A BITUMEN, GROUND TIRE RUBBER AND A COMPATIBILIZER

(71) Applicant: SABIC GLOBAL TECHNOLOGIES B.V., Bergen op Zoom (NL)

(72) Inventors: Maria Soliman, Selfkant (DE); Lidia Jasinska-Walc, Veldhoven (NL); Robbert Duchateau, Roostenlaan (NL); Miloud Bouyahyi, Eindhoven (NL); Mateusz Malus, Gdansk (PL); Joanna Bojda, Lodz (PL); Maciej Sienkiewicz, Gdansk (PL); Rasha H. Daadoush, Dhahran (SA); Maha Ali N. Alsayegh, Khobar (SA); Aaron Akah, Dhahran (SA)

(21) Appl. No.: 19/129,226

(22) PCT Filed: Nov. 15, 2023
(86) PCT No.: PCT/EP2023/081862

§ 371 Date: May 12, 2025

(30) Foreign Application Priority Data
Nov. 15, 2022 (EP) 22207483.3
Dec. 13, 2022 (EP) 22213294.6

(51) Int. Cl. C08L 53/00; C08L 9/00; C08L 23/16; C08L 53/02

(52) U.S. Cl. CPC C08L 53/00; C08L 9/00; C08L 23/16; C08L 53/02; C08L 2205/025; C08L 2666/04; C08L 2666/06

(57) ABSTRACT

Composite material for paving and roofing application, including recycled sulfur-vulcanized rubber between 5 to 20 wt % of the composite material, preferably 10 to 15 wt %, neat bitumen between 70 to 93 wt % of the composite material, preferably 80 to 90 wt %, a compatibilizer between 2 to 10 wt % of the composite material, preferably 2.5 to 7.5 wt % more preferably 4 to 6 wt % and including a hydroxyl-functionalized propylene-based copolymer preferably having hydroxyl-functionalized comonomer content between 0.1 and 0.6 mol %, more preferably 0.2 to 0.5 mol %, and an aluminum-containing residue including an elemental aluminum content from a quantity of 0 to 1.5 wt % of the hydroxyl-functionalized propylene-based copolymer.

### TECHNICAL FIELD OF THE INVENTION

The present invention relates to a sustainable modified bitumen composition of enhanced storage stability comprising ground tire rubber and a compatibilizer and its use in roof- or road construction applications.

### TECHNOLOGICAL BACKGROUND OF THE INVENTION

When added to bitumen, rubber tends to improve the lifespan of the bitumen composition by boosting its elasticity, low-temperature properties, and rutting resistance. Rubberized bitumen compositions are also known in the art to possess excellent noise dampening properties. By mixing rubberized bitumen compositions with mineral aggregates, so-called “quiet pavements” are constructed.

Virgin natural rubber is a suitable raw material for rubberized asphalt. However, in view of the increasing demand for sustainability, ground tire rubber (GTR), which can be considered as waste material, is an interesting alternative.

Rubberized asphalt is typically fabricated by the dry method consisting of mixing of the preheated aggregates with rubber particles at ambient temperature in a mobile mini hot-mix plants, followed by mixing it with the annealed, liquefied neat bitumen.

By using this method, several drawbacks are encountered such as (i) a brief contact time between binder and rubber filler, which limits the efficiency of neat bitumen modification, (ii) hampered compaction of rubberized asphalt, or (iii) the magnified emission of volatile organic compounds (VOCs) and polycyclic aromatic hydrocarbons (PAHs) at the road construction site.

Another way to produce rubberized asphalt is the application of the wet method consisting of premixing the neat bitumen with GTR particles at elevated temperatures (160-180° C.) using high-shear mixers. The resultant rubber-modified bitumen is then transferred to the mixing plant and mixed with the hot aggregates in a batch mixer. The advantage of this approach over the dry method is the extended impregnation efficiency leading to an improved interaction between GTR and neat bitumen, and also the reduction of the emissions of toxic fumes during the preparation of the rubber-modified bitumen in a closed plant system.

A well-known adjustment of the wet method of bitumen modification is the so-called terminal blend technology consisted of mixing GTR with neat bitumen at temperatures higher than 200° C. to partially cleave the sulfur crosslinks present within vulcanized rubber. This approach is beneficial in maintaining relatively low dynamic viscosity values, thus improving the processability of the resultant rubberized bitumen. The fractional, in-situ “devulcanization” of GTR particles in neat bitumen also serves in an enhanced dispersion of the rubber crumbs throughout the modified bitumen matrix.

Despite a great enhancement of the bitumen's performance, when processed through the wet or terminal blend method, GTR particles tend to phase separate from the bitumen matrix when stored and transported in static conditions at high temperatures. Consequently, rubber grains coalesce and settle down into the bottom of a storage tank, which have a detrimental effect on further processing of the rubberized bitumen and a deteriorated ductility of the material.

The most ubiquitous bitumen modifiers, viz. styrene-co-butadiene-co-styrene block copolymers (SBS), do not provide sufficient storage stability when mixed with low (approx. 5-10 wt. %) and medium (approx. 10-20 wt %) amounts of GTR in neat bitumen through the wet method. Therefore, such compositions are inadequate for application in road construction.

Therefore, there is a need for a suitable wet and terminal blend methods of bitumen modification to produce a mixture of rubber and bitumen designed for both paving and roofing applications using GTR and a compatibilizer to prevent the coalescence of rubber grains, which commonly leads to a deteriorated ductility and storage stability of the obtained material.

### SUMMARY

This objective is achieved by the present invention, a composite material for paving and roofing application, comprising
Sulfur-vulcanized rubber, preferably recycled one, between 5 to 20 wt % of the composite material, preferably 10 to 15 wt %
Neat bitumen between 70 to 93 wt % of the composite material, preferably 80 to 90 wt %
Compatibilizer between 2 to 10 wt % of the composite material, preferably 2.5 to 7.5 wt % more preferably 3 to 7 wt % and event more preferably 4 to 6 wt % and comprising
   a. a hydroxyl-functionalized propylene-based copolymer having a melting temperature Tm below 100° C., preferably below 90° C. more preferably 85° C., even more preferably below 80° C. and above 60° C. or be atactic, or syndiotactic and preferably having hydroxyl-functionalized comonomer content between 0.1 and 0.6 mol %, more preferably 0.2 to 0.5 mol %,
   b. aluminum-containing residue comprising an elemental aluminum content as for example aluminum oxide and/or aluminum hydroxide and/or aluminum alkoxide or a mixture of them, in a quantity of at least 0.1, preferably 0.29, preferably and at most 1.5, preferably at most 1.2 wt % of the hydroxyl-functionalized propylene-based copolymer

In another embodiment, the sulfur-vulcanized rubber is ground tire rubber, preferably used ground tire rubber.

In another embodiment, the hydroxyl-functionalized propylene-based copolymers is a polymer comprising propylene, optionally a second olefin monomer and a hydroxyl-functionalized olefin.

In another embodiment, the hydroxyl-functionalized propylene-based copolymers is either amorphous or semi-crystalline.

In another embodiment, the hydroxyl-functionalized propylene-based copolymers is selected from the list comprising poly(propylene-co-5-hexen-1-ol), poly(propylene-co-10-undecen-1-ol), poly(propylene-co-ethylene-co-5-hexen-1-ol), poly(propylene-co-ethylene-co-10-undecen-1-ol), poly(propylene-co-1-hexene-co-5-hexen-1-ol), poly(propylene-co-1-hexene-co-10-undecen-1-ol), poly(propylene-co-1-octene-co-5-hexen-1-ol), poly(propylene-co-1-octene-co-10-undecen-1-ol).

In another embodiment, the compatibilizer comprises poly(propylene-co-1-hexene-co-5-hexen-1-ol) and an aluminum-containing residue comprising an elemental aluminum content in a quantity 0.8 to 1.2 wt % of the hydroxyl-functionalized propylene-based copolymer.

In another embodiment, the hydroxyl-functionalized propylene-based copolymers is made in a solution polymerization process.

In another embodiment, the composite material has at least all of the followings:
Dynamic viscosity (η₁₈₀) at 180° C. not higher than 0.345 Pa-s according to EN 13302.
Avg. Penetration (P_{avg.})<54 dmm according to EN 1426, and
Avg. Softening point (SP_{avg.})>53° C. according to EN 1427, and
Δ Penetration (ΔP)<=10 dmm, preferably <=5 dmm, more preferably <=1 dmm according to EN 13399, and
Δ Softening point (ΔSP)<=10° C., preferably <=5° C., more preferably <=1° C. according to EN 13399, and
Performance Grade Plus (PG+) grade at 64° C. of V or E according to AASHTO M332-20.

In another embodiment, the composite material has at least all the followings:
Non-recoverable creep compliance J_{nr, 3.2 kPa}<1 preferably <0.6 kPa⁻¹ measured at 64° C., and
J_{nr, diff} at 64° C.<75% according to AASHTO M332-20, Performance Grade Plus (PG+) grade at 70° C. of S, H or V according to AASHTO M332-20, and
R_{3.2 kPa} at 64° C.>21% according to AASHTO M332-20

In another embodiment, the composite material has at least all of the followings:
Continuous PG>=85° C. according to ASTM D7643, and
Real PG>=82 according to AASHTO M320.

Another aspect of the invention is a process for making composite material according to one of the preceding claims, wherein the mixing of the neat bitumen with the sulfur-vulcanized rubber has been done under a wet process, at temperature range of 160 to 240° C., preferably 160 to 200° C., more preferably 170 to 190° C., under constant agitation of the mixture, preferably using a high-shear mixers, from 0.5 to 3 h, preferably from 1 to 2 h.

In another embodiment, the mixing of the neat bitumen with the sulfur-vulcanized rubber has been done under a terminal blend process, at temperature range of 230 to 260° C., preferably 240° C., under constant agitation of the mixture, preferably using a high-shear mixers, from 0.5 to 3 h, preferably from 1 to 2 h.

In another embodiment, the compatibilizer is added to mix of neat bitumen and sulfur-vulcanized rubber and the resulting rubber-modified bitumen mixture is stirred for additional time from 1 to 6 h, preferably 1 to 3 h, more preferably 1 to 2 h, under constant agitation, and maintaining a constant temperature in the range of 160-200° C.

In another embodiment, the process is performed under an inert atmosphere to hinder the thermal degradation of the compatibilizer.

A final aspect of the invention is the use of composite material according to one of the preceding claim for roofing applications, and it use for road application only when Δ Softening point (ΔSP)<=5° C.

### DETAILED DESCRIPTION

Designed to meet the needs of the road construction industry, the composition of the invention comprises a miscibility promoter (compatibilizer) to improve the interaction between GTR particles and bitumen components in order to prevent phase separation of the individual components of the system.

The present invention relates to the new paving and roofing composite material that facilitates a longer service life of the pavements and roofing fabrics by application of a cheap, post-consumer recycled material.

The present invention might be applied as a binding matrix for e.g. minerals and synthetic fillers. The thus obtained product can be used for the production of waterproofing materials like roofing membranes, sealants, and shingles. This matrix could further provide an enhanced adhesion of the resultant product to the standard roofing substrates like steel and concrete. Additionally, the structural features of the invention, ensuring the improved temperature susceptibility of a product, might limit the occurrence of undesired, temperature-induced defects of bituminous roofing materials like bleeding and thermal cracks.

Furthermore, the present invention might be also designed for road applications, serving as a binder between mineral aggregates in the hot and warm asphalt mixtures applied in the construction of pavements.

The objective of this invention is to introduce the new paving and roofing composite material comprising recycled sulfur-vulcanized rubber and a compatibilizer, having improved in-service performance when compared with neat bitumen, and revealing better storage stability and lower dynamic viscosity than GTR-modified bitumen compatibilized by corresponding or lower quantities of SBS copolymers.

Strikingly, the inventors of the disclosed application found that hydroxyl-functionalized propylene-based copolymers, preferably having a hydroxyl-functionalized comonomer content between 0.1 and 0.6 mol %, more preferably 0.2 to 0.5 mol %, are adequate to serve as a compatibilizer between GTR particles and the most polar bitumen group components i.e. resins and asphaltenes, improving the storage stability of the resultant blends, and a good alternative to SBS-based polymer bitumen modifiers.

Accordingly, the new paving and roofing composite material comprising recycled sulfur-vulcanized rubber with a sulfur content between 1-2 wt %, according to the invention comprises at least:
a. Neat bitumen
b. Ground tire rubber
c. Compatibilizer
wherein the compatibilizer comprises a hydroxyl-functionalized propylene-based copolymer,
where in the hydroxyl-functionalized propylene-based copolymer is a copolymer or propylene,
optionally a second non-functionalized olefin and a hydroxyl-functionalized olefin, and
wherein the paving or roofing composite material has at least a part or preferably all the followings:
   Dynamic viscosity (η₁₈₀) at 180° C. not higher than 0.345 Pa-s according to EN 13302,
Avg. Penetration (P_{avg.})<54 dmm according to EN 1426,
Avg. Softening point (SP_{avg})>53° C. according to EN 1427,
Δ Penetration (ΔP) Δ Penetration (ΔP)<=10 dmm, preferably 9 dmm, more preferably <=5 dmm, even more preferably <=1 dmm according to EN 13399
Δ Softening point (ΔSP)<=10° C., preferably <=5° C., more preferably <=1° C. according to EN 13399,
Performance Grade Plus (PG+) grade at 64° C. of V or E according to AASHTO M332-20,
Non-recoverable creep compliance J_{nr, 3.2 kPa}<1, preferably <0.6 kPa-measured at 64° C.,
J_{nr, diff} at 64° C.<75% according to AASHTO M332-20,
R_{3.2 kPa} at 64° C.>21% according to AASHTO M332-20
Continuous PG>=85° C. according to ASTM D7643,
Real PG>=82 according to AASHTO M320.

The hydroxyl-functionalized propylene-based copolymers is a polymer comprising propylene, optionally a second olefin monomer and a hydroxyl functionalized olefin, preferably having a hydroxyl-functionalized olefin comonomer content between 0.1 and 0.6 mol %, more preferably 0.2 to 0.5 mol %. The copolymer is either amorphous or semi-crystalline. The copolymer is either atactic, isotactic or syndiotactic.

The technology to obtain an paving and roofing composite material require to use adhesion promoter to improve the affinity of the bitumen to the Ground tire rubber, having a maximum melting temperature (Tm) below 160-260° C. as it is the range of temperature use in the process of making those composite material.

Surprisingly, the inventors discovered a threshold within the range of melting temperature (Tm) that need to be met in order to obtain an adhesion promoter suitable to be processed in an paving and roofing composite material and allowing good adhesion and physical (bulk) properties listed below. Tt is essential that the hydroxyl-functionalized propylene-based copolymers has a Tₘ below 100° C. in order to have a material with a viscosity compatible with the processing method.

Therefore, the hydroxyl-functionalized propylene-based copolymers according to the invention must have a melting temperature Tm below 100° C., preferably below 90° C. more preferably 85° C., even more preferably below 80° C. and above 60° C. or be atactic, or syndiotactic.

The hydroxyl-functionalized propylene-based copolymer is either amorphous or semi-crystalline.

The second olefin monomer can be selected from the group comprising: ethylene, 1-butene, 1-hexene, 1-octene, 1-decene.

The hydroxyl-functionalized propylene-based copolymers can produce in a solution process according to the process described in WO2022/106689 using one of the following catalyst: bis((2-oxoyl-3-(1,2,3,4,6,7,8,9-octahydroanthracen-5-yl)-5-(methyl)phenyl)-2-phenoxy)-1,3-propanediylhafnium (IV) dimethyl, bis((2-oxoyl-3-(1,2,3,4,6,7,8,9-octahydroanthracen-5-yl)-5-(methyl)phenyl)-2-phenoxy)-1,3-propanediylhafnium (IV) dichloride, bis((2-oxoyl-3-(1,2,3,4,6,7,8,9-octahydroanthracen-5-yl)-5-(methyl)phenyl)-2-phenoxy)-1,3-propanediylhafnium (IV) dibenzyl, bis((2-oxoyl-3-(dibenzo-1H-pyrrole-1-yl)-5-(methyl)phenyl)-2-phenoxy)-1,3-propanediylhafnium (IV) dimethyl, bis((2-oxoyl-3-(dibenzo-1H-pyrrole-1-yl)-5-(methyl)phenyl)-2-phenoxy)-1,3-propanediylhafnium (IV) dichloride, bis((2-oxoyl-3-(dibenzo-1H-pyrrole-1-yl)-5-(methyl)phenyl)-2-phenoxy)-1,3-propanediylhafnium (IV) dibenzyl, bis((2-oxoyl-3-(1,2,3,4,6,7,8,9-octahydroanthracen-5-yl)-5-(methyl)phenyl)-2-phenoxymethyl)-1,4-butanediylhafnium (IV) dimethyl, bis((2-oxoyl-3-(1,2,3,4,6,7,8,9-octahydroanthracen-5-yl)-5-(methyl)phenyl)-2-phenoxymethyl)-1,4-butanediylhafnium (IV) dichloride, bis((2-oxoyl-3-(1,2,3,4,6,7,8,9-octahydroanthracen-5-yl)-5-(methyl)phenyl)-2-phenoxymethyl)-1,4-butanediylhafnium (IV) dibenzyl, bis((2-oxoyl-3-(dibenzo-1H-pyrrole-1-yl)-5-(methyl)phenyl)-2-phenoxymethyl)-1,4-butanediylhafnium (IV)dimethyl, bis((2-oxoyl-3-(dibenzo-1H-pyrrole-1-yl)-5-(methyl)phenyl)-2-phenoxymethyl)-1,4-butanediylhafnium (IV) dichloride, bis((2-oxoyl-3-(dibenzo-1H-pyrrole-1-yl)-5-(methyl)phenyl)-2-phenoxymethyl)-1,4-butanediylhafnium (IV) dibenzyl, bis((2-oxoyl-3-(1,2,3,4,6,7,8,9-octahydroanthracen-5-yl)-5-(methyl)phenyl)-2-phenoxy)-2,4-pentanediylhafnium (IV) dimethyl, bis((2-oxoyl-3-(1,2,3,4,6,7,8,9-octahydroanthracen-5-yl)-5-(methyl)phenyl)-2-phenoxy)-2,4-pentanediylhafnium (IV) dichloride, bis((2-oxoyl-3-(1,2,3,4,6,7,8,9-octahydroanthracen-5-yl)-5-(methyl)phenyl)-2-phenoxy)-2,4-pentanediylhafnium (IV) dibenzyl, bis((2-oxoyl-3-(dibenzo-1H-pyrrole-1-yl)-5-(methyl)phenyl)-2-phenoxy)-2,4-pentanediylhafnium (IV) dimethyl, bis((2-oxoyl-3-(dibenzo-1H-pyrrole-1-yl)-5-(methyl)phenyl)-2-phenoxy)-2,4-pentanediylhafnium (IV) dichloride, bis((2-oxoyl-3-(dibenzo-1H-pyrrole-1-yl)-5-(methyl)phenyl)-2-phenoxy)-2,4-pentanediylhafnium (IV) dibenzyl, bis((2-oxoyl-3-(1,2,3,4,6,7,8,9-octahydroanthracen-5-yl)-5-(methyl)phenyl)-2-phenoxymethyl)-methylenetrans-1,2-cyclohexanediylhafnium (IV) dimethyl, bis((2-oxoyl-3-(1,2,3,4,6,7,8,9-octahydroanthracen-5-yl)-5-(methyl)phenyl)-2-phenoxymethyl)-methylenetrans-1,2-cyclohexanediylhafnium (IV) dichloride, bis((2-oxoyl-3-(1,2,3,4,6,7,8,9-octahydroanthracen-5-yl)-5-(methyl)phenyl)-2-phenoxymethyl)-methylenetrans-1,2-cyclohexanediylhafnium (IV) dibenzyl, bis((2-oxoyl-3-(dibenzo-1H-pyrrole-1-yl)-5-(methyl)phenyl)-2-phenoxymethyl)-methylenetrans-1,2-cyclohexanediylhafnium (IV) dimethyl, bis((2-oxoyl-3-(dibenzo-1H-pyrrole-1-yl)-5-(methyl)phenyl)-2-phenoxymethyl)-methylenetrans-1,2-cyclohexanediylhafnium (IV) dichloride, and bis((2-oxoyl-3-(dibenzo-1H-pyrrole-1-yl)-5-(methyl)phenyl)-2-phenoxymethyl)-methylenetrans-1,2-cyclohexanediylhafnium (IV) dibenzyl, bis((2-oxoyl-3-(dibenzo-1H-pyrrole-1-yl)phenyl)-2-phenoxy)-1,3-propylhafnium (IV) dibenzyl, bis((2-oxoyl-3-(dibenzo-1H-pyrrole-1-yl)phenyl)-2-phenoxy)-1,4-n-butylhafnium (IV) dimethyl, bis((2-oxoyl-3-(dibenzo-1H-pyrrole-1-yl)phenyl)-2-phenoxy)-1,4-n-butylhafnium (IV) dibenzyl, bis((2-oxoyl-3-(3,6-bis(1,1-dimethylethyl)-9H-carbazolyl)phenyl)-2-phenoxy)-1,3-propylhafnium (IV) dimethyl, bis((2-oxoyl-3-(3,6-bis(1,1-dimethylethyl)-9H-carbazolyl)phenyl)-2-phenoxy)-1,3-propylhafnium (IV) dibenzyl, bis((2-oxoyl-3-(3,6-bis(1,1-dimethylethyl)-9H-carbazolyl)phenyl)-2-phenoxy)-1,4-n-butylhafnium (IV) dimethyl, bis((2-oxoyl-3-(3,6-bis(1,1-dimethylethyl)-9H-carbazolyl)phenyl)-2-phenoxy)-1,4-n-butylhafnium (IV) dibenzyl, bis((2-oxoyl-3-(4-methoxy-3,5-bis(1,1-dimethylethyl)phenyl)phenyl)-2-phenoxy)-1,4-n-butylhafnium (IV) dimethyl, bis((2-oxoyl-3-(4-methoxy-3,5-bis(1,1-dimethylethyl)phenyl)phenyl)-2-phenoxy)-1,4-n-butylhafnium (IV) dibenzyl, bis((2-oxoyl-3-(dibenzo-1H-pyrrole-1-yl)phenyl)-2-phenoxy)-1,2-ethylhafnium (IV) dimethyl, bis((2-oxoyl-3-(dibenzo-1H-pyrrole-1-yl)phenyl)-2-phenoxy)-1,2-ethylhafnium (IV) dibenzyl, bis((2-oxoyl-3-(dibenzo-1H-pyrrole-1-yl)phenyl)-2-phenoxy)-1,3-propylhafnium (IV) dimethyl; preferably bis((2-oxoyl-3-(dibenzo-1H-pyrrole-1-yl)-5-(methyl)phenyl)-2-phenoxy)-2,4-pentanediylhafnium (IV) dimethyl, bis((2-oxoyl-3-(dibenzo-1H-pyrrole-1-yl)-5-(methyl)phenyl)-2-phenoxy)-2,4-pentanediylhafnium (IV) dichloride; or a zirconium complex of a polyvalent aryloxyether selected from the group: bis((2-oxoyl-3-(dibenzo-1H-pyrrole-1-yl)-5-(methyl)phenyl)-2-phenoxy)-2,4-pentanediylzirconium (IV) dimethyl, bis((2-oxoyl-3-(dibenzo-1H-pyrrole-1-yl)-5-(methyl)phenyl)-2-phenoxy)-2,4-pentanediylzirconium (IV) dichloride, bis((2-oxoyl-3-(1,2,3,4,6,7,8,9-octahydroanthracen-5-yl)-5-(methyl)phenyl)-2-phenoxy)-1,3-propanediylzirconium (IV) dimethyl, bis((2-oxoyl-3-(1,2,3,4,6,7,8,9-octahydroanthracen-5-yl)-5-(methyl)phenyl)-2-phenoxy)-1,3-propanediylzirconium (IV) dichloride, bis((2-oxoyl-3-(1,2,3,4,6,7,8,9-octahydroanthracen-5-yl)-5-(methyl)phenyl)-2-phenoxy)-1,3-propanediylzirconium (IV) dibenzyl, bis((2-oxoyl-3-(dibenzo-1H-pyrrole-1-yl)-5-(methyl)phenyl)-2-phenoxy)-1,3-propanediylzirconium (IV) dimethyl, bis((2-oxoyl-3-(dibenzo-1H-pyrrole-1-yl)-5-(methyl)phenyl)-2-phenoxy)-1,3-propanediylzirconium (IV) dichloride, bis((2-oxoyl-3-(dibenzo-1H-pyrrole-1-yl)-5-(methyl)phenyl)-2-phenoxy)-1,3-propanediylzirconium (IV) dibenzyl, bis((2-oxoyl-3-(1,2,3,4,6,7,8,9-octahydroanthracen-5-yl)-5-(methyl)phenyl)-2-phenoxymethyl)-1,4-butanediylzirconium (IV) dimethyl, bis((2-oxoyl-3-(1,2,3,4,6,7,8,9-octahydroanthracen-5-yl)-5-(methyl)phenyl)-2-phenoxymethyl)-1,4-butanediylzirconium (IV) dichloride, bis((2-oxoyl-3-(1,2,3,4,6,7,8,9-octahydroanthracen-5-yl)-5-(methyl)phenyl)-2-phenoxymethyl)-1,4-butanediylzirconium (IV) dibenzyl, bis((2-oxoyl-3-(dibenzo-1H-pyrrole-1-yl)-5-(methyl)phenyl)-2-phenoxymethyl)-1,4-butanediylzirconium (IV)dimethyl, bis((2-oxoyl-3-(dibenzo-1H-pyrrole-1-yl)-5-(methyl)phenyl)-2-phenoxymethyl)-1,4-butanediylzirconium (IV) dichloride, bis((2-oxoyl-3-(dibenzo-1H-pyrrole-1-yl)-5-(methyl)phenyl)-2-phenoxymethyl)-1,4-butanediylzirconium (IV) dibenzyl, bis((2-oxoyl-3-(1,2,3,4,6,7,8,9-octahydroanthracen-5-yl)-5-(methyl)phenyl)-2-phenoxy)-2,4-pentanediylzirconium (IV) dimethyl, bis((2-oxoyl-3-(1,2,3,4,6,7,8,9-octahydroanthracen-5-yl)-5-(methyl)phenyl)-2-phenoxy)-2,4-pentanediylzirconium (IV) dichloride, bis((2-oxoyl-3-(1,2,3,4,6,7,8,9-octahydroanthracen-5-yl)-5-(methyl)phenyl)-2-phenoxy)-2,4-pentanediylzirconium (IV) dibenzyl, bis((2-oxoyl-3-(dibenzo-1H-pyrrole-1-yl)-5-(methyl)phenyl)-2-phenoxy)-2,4-pentanediylzirconium (IV) dibenzyl, bis((2-oxoyl-3-(1,2,3,4,6,7,8,9-octahydroanthracen-5-yl)-5-(methyl)phenyl)-2-phenoxymethyl)-methylenetrans-1,2-cyclohexanediylzirconium (IV) dimethyl, bis((2-oxoyl-3-(1,2,3,4,6,7,8,9-octahydroanthracen-5-yl)-5-(methyl)phenyl)-2-phenoxymethyl)-methylenetrans-1,2-cyclohexanediylzirconium (IV) dichloride, bis((2-oxoyl-3-(1,2,3,4,6,7,8,9-octahydroanthracen-5-yl)-5-(methyl)phenyl)-2-phenoxymethyl)-methylenetrans-1,2-cyclohexanediylzirconium (IV) dibenzyl, bis((2-oxoyl-3-(dibenzo-1H-pyrrole-1-yl)-5-(methyl)phenyl)-2-phenoxymethyl)-methylenetrans-1,2-cyclohexanediylzirconium (IV) dimethyl, bis((2-oxoyl-3-(dibenzo-1H-pyrrole-1-yl)-5-(methyl)phenyl)-2-phenoxymethyl)-methylenetrans-1,2-cyclohexanediylzirconium (IV) dichloride, and bis((2-oxoyl-3-(dibenzo-1H-pyrrole-1-yl)-5-(methyl)phenyl)-2-phenoxymethyl)-methylenetrans-1,2-cyclohexanediylzirconium (IV) dibenzyl, bis((2-oxoyl-3-(4-methoxy-3,5-bis(1,1-dimethylethyl)phenyl)phenyl)-2-phenoxy)-1,4-n-butylzirconium (IV) dimethyl, bis((2-oxoyl-3-(4-methoxy-3,5-bis(1,1-dimethylethyl)phenyl)phenyl)-2-phenoxy)-1,4-n-butylzirconium (IV) dibenzyl, bis((2-oxoyl-3-(dibenzo-1H-pyrrole-1-yl)phenyl)-2-phenoxy)-1,2-ethylzirconium (IV) dimethyl, bis((2-oxoyl-3-(dibenzo-1H-pyrrole-1-yl)phenyl)-2-phenoxy)-1,2-ethylzirconium (IV) dibenzyl, bis((2-oxoyl-3-(dibenzo-1H-pyrrole-1-yl)phenyl)-2-phenoxy)-1,3-propylzirconium (IV) dimethyl, bis((2-oxoyl-3-(dibenzo-1H-pyrrole-1-yl)phenyl)-2-phenoxy)-1,3-propylzirconium (IV) dibenzyl, bis((2-oxoyl-3-(dibenzo-1H-pyrrole-1-yl)phenyl)-2-phenoxy)-1,4-n-butylzirconium (IV) dimethyl, bis((2-oxoyl-3-(dibenzo-1H-pyrrole-1-yl)phenyl)-2-phenoxy)-1,4-n-butylzirconium (IV) dibenzyl, bis((2-oxoyl-3-(3,6-bis(1,1-dimethylethyl)-9H-carbazolyl)phenyl)-2-phenoxy)-1,3-propylzirconium (IV) dimethyl, bis((2-oxoyl-3-(3,6-bis(1,1-dimethylethyl)-9H-carbazolyl)phenyl)-2-phenoxy)-1,3-propylzirconium (IV) dibenzyl, bis((2-oxoyl-3-(3,6-bis(1,1-dimethylethyl)-9H-carbazolyl)phenyl)-2-phenoxy)-1,4-n-butylzirconium (IV) dimethyl, bis((2-oxoyl-3-(3,6-bis(1,1-dimethylethyl)-9H-carbazolyl)phenyl)-2-phenoxy)-1,4-n-butylzirconium (IV) dibenzyl; preferably bis((2-oxoyl-3-(dibenzo-1H-pyrrole-1-yl)-5-(methyl)phenyl)-2-phenoxy)-2,4-pentanediylzirconium (IV) dimethyl, bis((2-oxoyl-3-(dibenzo-1H-pyrrole-1-yl)-5-(methyl)phenyl)-2-phenoxy)-2,4-pentanediylzirconium (IV) dichloride;

Other suitable metal catalyst precursors can also be the trivalent transition metal as those described in WO 9319104 or in WO 9613529, for example [(C₅H₄)CH₂CH₂N(Me)₂]MCl₂, [(C₅Me₄)CH₂CH₂N(Me)₂]MCl₂, [(C₅H₄)CH₂CH₂N(i-Pr)₂]MCl₂, [(C₅Me₄)CH₂CH₂N(i-Pr)₂]MCl₂, [(C₅H₄)CH₂CH₂N(n-Bu)₂]MCl₂, [(C₅Me₄)CH₂CH₂N(n-Bu)₂]MCl₂, [(C₉H₆)CH₂CH₂N(Me)₂]MCl₂, [(C₉H₆)CH₂CH₂N(i-Pr)₂]MCl₂, [(C₅Me₄)C₉H₆N]MCl₂, [(C₅Me₃(SiMe₃))C₉H₆N]MCl₂, [(C₉H₆)C₉H₆N]MCl₂, [(C₅Me₄)CH₂C₅H₄N]MCl₂ or [(C₉H₆)CH₂C₅H₄N]MCl₂, where M is titanium or chromium. Examples of catalyst precursors are (C₅Me₄)CH₂CH₂N(Me)₂]TiCl₂, [C₆H₅C(NSiMe₃)₂]TiCl₂(THF)₂ and [C₆H₅C(NSiMe₃)CH₂CH₂N(CH₃)₂]TiCl₂(THF).

Other non-limiting examples of metal catalyst precursors that would be suitable according to the present invention are: (pyrrolidinyl)ethyl-tetramethylcyclopentadienyl titanium dichloride, (N,N-dimethylamino)ethyl-fluorenyl titanium dichloride, (bis(1-methyl-ethyl)phosphino)ethyl-tetramethylcyclopentadienyl titanium dichloride, (bis(2-methyl-propyl)phosphino)ethyl-tetramethylcyclopentadienyl titanium dichloride, (diphenylphosphino)ethyl-tetramethylcyclopentadienyl titanium dichloride, (diphenylphosphino)methyldimethylsilyl-tetramethylcyclopentadienyl titanium dichloride.

According to the invention, other suitable catalyst precursors can be for example {N′,N″-bis[2,6-di(1-methylethyl)phenyl]-N,N-diethylguanidinato}metal dichloride, {N′,N″bis[2,6-di(1-methylethyl)phenyl]-N-methyl-N-cyclohexylguanidinato}metal dichloride, {N′,N″-bis[2,6-di(1-methylethyl)phenyl]-N,N-pentamethyleneguanidinato}metal dichloride, {N′,N″-bis[2,6-di(methyl)phenyl]-sec-butyl-aminidinato}metal dichloride, {N,N′-bis(trimethylsilyl)benzamidinato}metal dichloride, {N-trimethylsilyl,N′—(N″,N″-dimethylaminomethyl)benzamidinato}metal dichloride and their THE or other Lewis base adducts, where metal is titanium or chromium.

Other suitable metal catalyst precursors can also be hafnium or zirconium or titanium complex supported by a dianionic tri- and/or tetra-dentate ligand as 2′-((3-(9H-carbazol-9-yl)-2-olato-5-methylphenyl)(3-methoxypropyl)amino)-3-(9H-carbazol-9-yl)-5-methyl-[1,1′-biphenyl]-2-olato]dimethyl hafnium; 2′-((3-(9H-carbazol-9-yl)-2-olato-5-methylphenyl)(3-methoxypropyl)amino)-3-(9H-carbazol-9-yl)-5-methyl-[1,1′-biphenyl]-2-olato]dimethyl zirconium; [2′-((3-(9H-carbazol-9-yl)-2-olato-5-methylphenyl)(3-methoxypropyl)amino)-3-(adamantan-1-yl)-5-methyl-[1,1′-biphenyl]-2-olato]dimethyl hafnium; [2′-((3-(9H-carbazol-9-yl)-2-olato-5-methylphenyl)(3-methoxypropyl)amino)-3-(adamantan-1-yl)-5-methyl-[1,1′-biphenyl]-2-olato]dimethyl zirconium; [2′-((3-(adamantan-1-yl)-2-olato-5-methylphenyl)(3-methoxypropyl)amino)-3-(9H-carbazol-9-yl)-5-methyl-[1,1′-biphenyl]-2-olato]dimethyl zirconium; [2′-((3-(adamantan-1-yl)-2-olato-5-methylphenyl)(3-methoxypropyl)amino)-3-(9H-carbazol-9-yl)-5-methyl-[1,1′-biphenyl]-2-olato]dimethyl hafnium; [2′-((3-(adamantan-1-yl)-2-olato-5-methylphenyl)(2-methoxyethyl)amino)-3-(9H-carbazol-9-yl)-5-methyl-[1,1′-biphenyl]-2-olato]dimethyl zirconium; [2′-((3-(adamantan-1-yl)-2-olato-5-methylphenyl)(2-methoxyethyl)amino)-3-(9H-carbazol-9-yl)-5-methyl-[1,1′-biphenyl]-2-olato]dimethyl hafnium; [2′-((3-((3r,5r,7r)-adamantan-1-yl)-2-hydroxy-5-methylphenyl)(3-methoxypropyl)amino)-3-(tert-butyl)-5-methyl-[1,1′-biphenyl]-2-olato]dibenzyl zirconium; [2′-((3-((3r,5r,7r)-adamantan-1-yl)-2-hydroxy-5-methylphenyl)(3-methoxypropyl)amino)-3-(tert-butyl)-5-methyl-[1,1′-biphenyl]-2-olato]dibenzyl zirconium; [3-(tert-butyl)-2′-((3-(tert-butyl)-2-hydroxy-5-methylphenyl)(3-methoxypropyl)amino)-5-methyl-[1,1′-biphenyl]-2-olato]dibenzyl zirconium; [3-(tert-butyl)-2′-((3-(tert-butyl)-2-hydroxy-5-methylphenyl)(3-methoxypropyl)amino)-5-methyl-[1,1′-biphenyl]-2-olato]dibenzyl hafnium; [3-(tert-butyl)-2′-((3-(tert-butyl)-2-hydroxy-5-methylphenyl)(3-methoxypropyl)amino)-5-methyl-[1,1′-biphenyl]-2-olato]dimethyl hafnium; [3-(tert-butyl)-2′-((3-(tert-butyl)-2-hydroxy-5-methylphenyl)(3-methoxypropyl)amino)-5-methyl-[1,1′-biphenyl]-2-olato]dimethyl zirconium; [3-(tert-butyl)-2′-((3-methoxypropyl)(5-methyl-2-(p-tolylamino)phenyl)amino)-5-methyl-[1,1′-biphenyl]-2-olato]dimethyl hafnium; [3-(tert-butyl)-2′-((3-methoxypropyl)(5-methyl-2-(p-tolylamino)phenyl)amino)-5-methyl-[1,1′-biphenyl]-2-olato]dimethyl zirconium; [3-(tert-butyl)-2′-((2-methoxyethyl)(2-((4-methoxyphenyl)amino)-5-methylphenyl)amino)-5-methyl-[1,1′-biphenyl]-2-olato]dimethyl hafnium; [3-(tert-butyl)-2′-((2-methoxyethyl)(2-((4-methoxyphenyl)amino)-5-methylphenyl)amino)-5-methyl-[1,1′-biphenyl]-2-olato]dimethyl zirconium; [3-(tert-butyl)-2′-((2-methoxyethyl)(5-methyl-2-(p-tolylamino)phenyl)amino)-5-methyl-[1,1′-biphenyl]-2-olato]dimethyl hafnium; [3-(tert-butyl)-2′-((2-methoxyethyl)(5-methyl-2-(p-tolylamino)phenyl)amino)-5-methyl-[1,1′-biphenyl]-2-olato]dimethyl zirconium; [3-(tert-butyl)-2′-((2-methoxyethyl)(5-isopropyl-2-(p-tolylamino)phenyl)amino)-5-methyl-[1,1′-biphenyl]-2-olato]dimethyl hafnium; [3-(tert-butyl)-2′-((2-methoxyethyl)(5-isopropyl-2-(p-tolylamino)phenyl)amino)-5-methyl-[1,1′-biphenyl]-2-olato]dimethyl zirconium; [3-(tert-butyl)-2′-((3-(tert-butyl)-2-hydroxy-5-methylphenyl)(3-methoxypropyl)amino)-5-methyl-[1,1′-biphenyl]-2-olato]dimethyl hafnium; [3-(tert-butyl)-2′-((3-(tert-butyl)-2-hydroxy-5-methylphenyl)(3-methoxypropyl)amino)-5-methyl-[1,1′-biphenyl]-2-olato]dimethyl zirconium; [25: 3-(tert-butyl)-2′-((3-(tert-butyl)-2-hydroxy-5-methylphenyl)(3-methoxypropyl)amino)-5-methyl-[1,1′-biphenyl]-2-olato]dichloro titanium; [3-(tert-butyl)-2′-((3-(tert-butyl)-2-hydroxy-5-methylphenyl)(2-methoxyethyl)amino)-5-methyl-[1,1′-biphenyl]-2-olato]monochloro dimethylamido titanium; [3-(tert-butyl)-2′-((3-(tert-butyl)-2-hydroxy-5-methylphenyl)(2-methoxyethyl)amino)-5-methyl-[1,1′-biphenyl]-2-olato]dichloro titanium; [3-(tert-butyl)-2′-((3-(tert-butyl)-2-hydroxy-5-methylphenyl)(2-methoxyethyl)amino)-5-methyl-[1,1′-biphenyl]-2-olato]dimethyl zirconium; [3-(tert-butyl)-2′-((3-(tert-butyl)-2-hydroxy-5-methylphenyl)(2-methoxyethyl)amino)-5-methyl-[1,1′-biphenyl]-2-olato]dimethyl hafnium; [2′-((3-(9H-carbazol-9-yl)-2-hydroxy-5-methylphenyl)(2-(dimethylamino)ethyl)amino)-3-(tert-butyl)-5-methyl-[1,1′-biphenyl]-2-olato]dibenzyl hafnium; [2′-((3-(9H-carbazol-9-yl)-2-hydroxy-5-methylphenyl)(2-(dimethylamino)ethyl)amino)-3-(tert-butyl)-5-methyl-[1,1′-biphenyl]-2-olato]dimethyl hafnium; [2′-((3-(9H-carbazol-9-yl)-2-hydroxy-5-methylphenyl)(2-(dimethylamino)ethyl)amino)-3-(tert-butyl)-5-methyl-[1,1′-biphenyl]-2-olato]dimethyl zirconium; [2′-((3-(9H-carbazol-9-yl)-2-hydroxy-5-methylphenyl)(2-methoxyethyl)amino)-3-(tert-butyl)-5-methyl-[1,1′-biphenyl]-2-olato]dibenzyl hafnium; [2′-((3-(9H-carbazol-9-yl)-2-hydroxy-5-methylphenyl)(2-methoxyethyl)amino)-3-(tert-butyl)-5-methyl-[1,1′-biphenyl]-2-olato]dimethyl hafnium; [2′-((3-(9H-carbazol-9-yl)-2-hydroxy-5-methylphenyl)(2-methoxyethyl)amino)-3-(tert-butyl)-5-methyl-[1,1′-biphenyl]-2-olato]dibenzyl zirconium; [2′-((3-(9H-carbazol-9-yl)-2-hydroxy-5-methylphenyl)(2-methoxyethyl)amino)-3-(tert-butyl)-5-methyl-[1,1′-biphenyl]-2-olato]dimethyl zirconium; [2′-((3-(9H-carbazol-9-yl)-2-hydroxy-5-methylphenyl)(2-methoxyethyl)amino)-3-(9H-carbazol-9-yl)-5-methyl-[1,1′-biphenyl]-2-olato]dibenzyl hafnium; [2′-((3-(9H-carbazol-9-yl)-2-hydroxy-5-methylphenyl)(2-methoxyethyl)amino)-3-(9H-carbazol-9-yl)-5-methyl-[1,1′-biphenyl]-2-olato]dimethyl hafnium; [2′-((3-(9H-carbazol-9-yl)-2-hydroxy-5-methylphenyl)(2-methoxyethyl)amino)-3-(9H-carbazol-9-yl)-5-methyl-[1,1′-biphenyl]-2-olato]dibenzyl zirconium; [2′-((3-(9H-carbazol-9-yl)-2-hydroxy-5-methylphenyl)(2-methoxyethyl)amino)-3-(9H-carbazol-9-yl)-5-methyl-[1,1′-biphenyl]-2-olato]dimethyl zirconium; [3-((1s,3s)-adamantan-1-yl)-2′-((3-((3r,5r,7r)-adamantan-1-yl)-2-hydroxy-5-methylphenyl)(2-methoxyethyl)amino)-5-methyl-[1,1′-biphenyl]-2-olato]dimethyl hafnium; [3-((1 s,3s)-adamantan-1-yl)-2′-((3-((3r,5r,7r)-adamantan-1-yl)-2-hydroxy-5-methylphenyl)(2-methoxyethyl)amino)-5-methyl-[1,1′-biphenyl]-2-olato]dimethyl zirconium; [6,6′-(((2-methoxyethyl)azanediyl)bis(methylene))bis(2,4-di-tert-butylphenolato) dibenzyl hafnium; [6,6′-(((2-methoxyethyl)azanediyl)bis(methylene))bis(2,4-di-tert-butylphenolato) dibenzyl zirconium; [2-(tert-butyl)-6-((3-methoxypropyl)(2′-(p-tolylamino)-[1,1′-biphenyl]-2-yl)amino)-4-methylphenolato]dimethyl hafnium; [3-(tert-butyl)-2′-((3-(tert-butyl)-2-hydroxy-5-methylphenyl)(3-phenoxypropyl)amino)-5-methyl-[1,1′-biphenyl]-2-olato]dimethyl hafnium; [3-(tert-butyl)-2′-((3-(tert-butyl)-2-hydroxy-5-methoxyphenyl)(3-methoxypropyl)amino)-5-methyl-[1,1′-biphenyl]-2-olato]dimethyl zirconium; [3-(tert-butyl)-2′-((3-(tert-butyl)-2-hydroxy-5-(trifluoromethyl)phenyl)(3-methoxypropyl)amino)-5-methyl-[1,1′-biphenyl]-2-olato]dibenzyl zirconium; [3-(tert-butyl)-2′-((3-(tert-butyl)-2-hydroxy-5-methylphenyl)(3-(phenylthio)propyl)amino)-5-methyl-[1,1′-biphenyl]-2-olato]dimethyl hafnium; →[3-(tert-butyl)-2′-((3-(tert-butyl)-2-hydroxy-5-methylphenyl)(3-(phenylthio)propyl)amino)-5-methyl-[1,1′-biphenyl]-2-olato]dimethyl zirconium; [3-(tert-butyl)-2′-((3-methoxypropyl)(5-methyl-2-(p-tolylamino)phenyl)amino)-5-methyl-[1,1′-biphenyl]-2-olato]dichloro titanium; 3-(tert-butyl)-2′-((2-methoxyethyl)(5-methyl-2-(p-tolylamino)phenyl)amino)-5-methyl-[1,1′-biphenyl]-2-olato]dichloro titanium; [3″,5″-di-tert-butyl-2-((3-(tert-butyl)-2-hydroxy-5-methylphenyl)(3-methoxypropyl)amino)-5′-methyl-[1,1′:3′,1″-terphenyl]-2′-olato]dimethyl hafnium; 3-(tert-butyl)-2′-((3-(tert-butyl)-2-hydroxy-5-methylphenyl)(2-ethoxyethyl)amino)-5-methyl-[1,1′-biphenyl]-2-olato]dichloro titanium; 3-(tert-butyl)-2′-(butyl(3-(tert-butyl)-2-hydroxy-5-methylphenyl)amino)-5-methyl-[1,1′-biphenyl]-2-olato]dibenzyl hafnium; 3-(tert-butyl)-2′-(butyl(3-(tert-butyl)-2-hydroxy-5-methylphenyl)amino)-5-methyl-[1,1′-biphenyl]-2-olato]dibenzyl zirconium; [2″-((3-(tert-butyl)-2-hydroxy-5-methylphenyl)(3-methoxypropyl)amino)-2,4,5′,6-tetramethyl-[1,1′:3′,1″-terphenyl]-2′-olato]dimethyl zirconium; [3-(tert-butyl)-2′-((3-(tert-butyl)-2-hydroxy-5-methylphenyl)(3-(dimethylamino)propyl)amino)-[1,1′-biphenyl]-2-olato]dibenzyl zirconium; [N2-(3-methoxypropyl)-N2-(5-methyl-2-(p-tolylamino)phenyl)-N2′-(p-tolyl)-[1,1′-biphenyl]-2,2′-diamino]dichloro hafnium; [N2-(3-methoxypropyl)-N2-(5-methyl-2-(p-tolylamino)phenyl)-N2′-(p-tolyl)-[1,1′-biphenyl]-2,2′-diamino]dichloro zirconium; [N2-(3-methoxypropyl)-N2-(5-methyl-2-(p-tolylamino)phenyl)-N2′-(p-tolyl)-[1,1′-biphenyl]-2,2′-diamino]dimethyl hafnium; [N2-(3-methoxypropyl)-N2-(5-methyl-2-(p-tolylamino)phenyl)-N2′-(p-tolyl)-[1,1′-biphenyl]-2,2′-diamino]dimethyl zirconium; 3-(tert-butyl)-2′-((3-(tert-butyl)-2-hydroxy-5-methylphenyl)(3-(dimethylamino)propyl)amino)-5-methyl-[1,1′-biphenyl]-2-olato]dichloro titanium; [2′-((3-((3r,5r,7r)-adamantan-1-yl)-2-hydroxy-5-methylphenyl)(3-methoxypropyl)amino)-3-(tert-butyl)-5-methyl-[1,1′-biphenyl]-2-olato]dichloro titanium; [2′-((3-((3r,5r,7r)-adamantan-1-yl)-2-hydroxy-5-methylphenyl)(3-methoxypropyl)amino)-3-(tert-butyl)-5-methyl-[1,1′-biphenyl]-2-olato]dimethyl hafnium; [3-(tert-butyl)-2′-((3-(tert-butyl)-2-hydroxy-5-methylphenyl)(4-methoxybutyl)amino)-5-methyl-[1,1′-biphenyl]-2-olato]dimethyl hafnium; [3-(tert-butyl)-2′-((3-(tert-butyl)-2-hydroxy-5-methylphenyl)(4-methoxybutyl)amino)-5-methyl-[1,1′-biphenyl]-2-olato]dimethyl zirconium; [3-(tert-butyl)-2′-((3-(tert-butyl)-2-hydroxy-5-methylphenyl)(3-ethoxypropyl)amino)-5-methyl-[1,1′-biphenyl]-2-olato]dimethyl zirconium; [3-(tert-butyl)-2′-((3-(tert-butyl)-2-hydroxy-5-methylphenyl)(3-ethoxypropyl)amino)-5-methyl-[1,1′-biphenyl]-2-olato]dichloro titanium; [2″-((3-(tert-butyl)-2-hydroxy-5-methylphenyl)(3-methoxypropyl)amino)-2,4,5′,6-tetramethyl-[1,1′:3′,1″-terphenyl]-2′-olato]dimethyl hafnium; [3-((1S,3s)-adamantan-1-yl)-2′-((3-(tert-butyl)-2-hydroxy-5-methylphenyl)(3-methoxypropyl)amino)-5-methyl-[1,1′-biphenyl]-2-olato]dimethyl hafnium; [3-((1S,3s)-adamantan-1-yl)-2′-((3-(tert-butyl)-2-hydroxy-5-methylphenyl)(3-methoxypropyl)amino)-5-methyl-[1,1′-biphenyl]-2-olato]dimethyl zirconium; [2-(tert-butyl)-6-((2′-(isopropylamino)-5′-methyl-[1,1′-biphenyl]-2-yl)(3-methoxypropyl)amino)-4-methylphenolato]dibenzyl hafnium; [2-(tert-butyl)-6-((2′-(isopropylamino)-5′-methyl-[1,1′-biphenyl]-2-yl)(3-methoxypropyl)amino)-4-methylphenolato]dibenzyl zirconium; [2′-((3-(tert-butyl)-2-hydroxy-5-methylphenyl)(3-methoxypropyl)amino)-5-methyl-3-(2-phenylpropan-2-yl)-[1,1′-biphenyl]-2-olato]dimethyl hafnium; [2′-((3-(tert-butyl)-2-hydroxy-5-methylphenyl)(3-methoxypropyl)amino)-5-methyl-3-(2-phenylpropan-2-yl)-[1,1′-biphenyl]-2-olato]dimethyl zirconium; [2′-((3-(tert-butyl)-2-hydroxy-5-methylphenyl)(3-methoxypropyl)amino)-5-methyl-3-(2-phenylpropan-2-yl)-[1,1′-biphenyl]-2-olato]dimethyl zirconium, and
a co-catalyst selected from the group: MAO, DMAO, MMAO, SMAO or ammonium salts or trityl salts of fluorated tetraarylborates, preferably MAO, MMAO, and
optionally, a scavenger selected from the group: trimethyl aluminum, triethyl aluminum, triisobutyl aluminum, trihexyl aluminum, trioctyl aluminum and optionally, a chain transfer agent selected from the group: dihydrogen, AlR₃, BR₃, MgR₂ or ZnR₂, where each R is independently selected from hydrogen or hydrocarbyl.

Preferably, the hydroxyl-functionalized propylene-based copolymers can be selected from the group comprising: poly(propylene-co-5-hexen-1-ol), poly(propylene-co-10-undecen-1-ol), poly(propylene-co-ethylene-co-5-hexen-1-ol), poly(propylene-co-ethylene-co-10-undecen-1-ol), poly(propylene-co-1-hexene-co-5-hexen-1-ol), poly(propylene-co-1-hexene-co-10-undecen-1-ol), poly(propylene-co-1-octene-co-5-hexen-1-ol), poly(propylene-co-1-octene-co-10-undecen-1-ol) or a mixture of them, more preferably selected from poly(propylene-co-5-hexen-1-ol), poly(propylene-co-ethylene-co-5-hexen-1-ol), poly(propylene-co-1-hexene-co-5-hexen-1-ol), poly(propylene-co-1-octene-co-5-hexen-1-ol).

Preferably, the amount of hydroxyl-functionalized propylene-based copolymers within the paving and roofing composite material is between 2 wt % and 10 wt %, preferably 2 wt % and 7 wt %, and more preferably 2.5 and 5 wt %.

In a preferred embodiment, the compatibilizer could further comprise, in addition of the hydroxyl-functionalized propylene-based copolymer, an aluminum-containing residue. As inventors surprisingly discovered that the interaction of an aluminum-containing residue with the copolymers structure can increase stiffness, compatibility and softening point of the composite.

The amount of an elemental aluminum shall not be above 1.5 wt % of the hydroxyl-functionalized propylene-based copolymer within the asphalt composition, as its presence within the asphalt composition decreases the adhesion to the mineral aggregates. Preferably, the amount of an elemental aluminum content is between 0.1 and 0.5 wt %, preferably 0.2 and 0.4 wt % of the hydroxyl-functionalized propylene-based copolymer.

The aluminum-containing residue comprising an elemental aluminum content may be for example an aluminum oxide and/or an aluminum hydroxide and/or an aluminum alkoxide or a mixture of them, preferably according to the formula: Al(O)ₓ(OH)_{y}(OR)_{z} where x=0-1.5, y=0-3, z=0-3 and (2 x+y+z)=3 and wherein R is an aliphatic hydrocarbyl group, preferably from C₁ to C₆, preferably Me, Et, nPr, iPr, nBu, iBu, or tBu, even more preferably isopropyl.

The introduction of an aluminum-containing residue can be achieved by incorporation of organoaluminum compounds, more preferably aluminum alkyls, at the commencement stage of the copolymers synthesis. These aluminum alkyls can react with the hydroxyl functionality of the functionalized comonomer. Aluminum alkyls species are known in the art, in particular in WO2022/106689 as functional comonomer passivating agents, which prevent poisoning and deactivation of the catalyst's oxophilic metal center during the polymerization. Hydrolysis of the aluminum alkyl-passivated hydroxyl-functionalized propylene-based copolymers affords hydroxyl-functionalized propylene-based copolymers having finely dispersed aluminum-containing residue.

Preferably, aluminum alkyl precursors providing, after hydrolysis of the polymeric product at the end of the polymerization process, crosslinking of hydroxyl-functionalized comonomer segments within propylene-based copolymers architecture in the form of an aluminum-containing residue nodes, can be selected from the group comprising: trioctylaluminum (TOA), triisobutylaluminum (TiBA), triethylaluminum (TEA), methylaluminumoxane (MAO), trimethyl aluminum (TMA) or a mixture thereof.

In some embodiment, which contains an aluminum-containing residue, the aluminum-containing residue originates from hydrolysis of the aluminum alkyl is the passivating agent used to passivate the hydroxyl functional groups of the functional monomers during the synthesis of the hydroxyl-functionalized propylene-based copolymer.

In a more preferred embodiment, the new paving and roofing composite material according to the invention comprises:
a. A neat bitumen in a quantity from 75 to 87.5 wt. % of the composite material composition
b. A ground tire rubber—in a quantity from 10 to 20 wt. % of the composite material composition
c. A hydroxyl-functionalized propylene-based copolymer, preferably selected from poly(propylene-co-5-hexen-1-ol), poly(propylene-co-ethylene-co-5-hexen-1-ol), poly(propylene-co-1-hexene-co-5-hexen-1-ol), poly(propylene-co-1-octene-co-5-hexen-1-ol), in a quantity from 2.5 to 5.0 wt % of the composite material composition, and
d. An aluminum-containing residue comprising an elemental aluminum content from a quantity of 0.1 to 1.5 wt % of the hydroxyl-functionalized propylene-based copolymer within the composite material composition.

In an even more preferred embodiment, the new paving and roofing composite material according to the invention comprises:
a. A neat bitumen in a quantity of 85 wt % of the composite material composition
b. A ground tire rubber in a quantity of 10 wt % of the composite material composition
c. A hydroxyl-functionalized propylene-based copolymer, preferably selected from poly(propylene-co-5-hexen-1-ol), poly(propylene-co-ethylene-co-5-hexen-1-ol), poly(propylene-co-1-hexene-co-5-hexen-1-ol), poly(propylene-co-1-octene-co-5-hexen-1-ol), more preferably poly(propylene-co-1-hexene-co-5-hexen-1-ol) in a quantity from 2.5 to 5.0 wt % of the composite material, and
d. An aluminum-containing residue comprising an elemental aluminum content from a quantity of 0.1 to 1.5 wt %, more preferably from 0.5 to 1.0 wt % of the hydroxyl-functionalized propylene-based copolymer.

Another aspect of the invention is the compatibilizer comprising:
a. A hydroxyl-functionalized propylene-based copolymer, preferably selected from poly(propylene-co-5-hexen-1-ol), poly(propylene-co-ethylene-co-5-hexen-1-ol), poly(propylene-co-1-hexene-co-5-hexen-1-ol), poly(propylene-co-1-octene-co-5-hexen-1-ol), and
b. An aluminum-containing residue comprising an elemental aluminum content from a quantity of 0.1 to 1.5 wt % of the hydroxyl-functionalized propylene-based copolymer.

In a preferred embodiment the compatibilizer comprises:
a. A hydroxyl-functionalized propylene-based copolymer, more preferably selected from poly(propylene-co-1-hexene-co-5-hexen-1-ol)
b. An aluminum-containing residue comprising an elemental aluminum content of a quantity of 1.5 wt % of the hydroxyl-functionalized propylene-based copolymer.

in an even more preferred embodiment, the new paving and roofing composite material according to the invention comprises:
A compatibilizer having this specific composition:
   a. A hydroxyl-functionalized propylene-based copolymer viz. poly(propylene-co-1-hexene-co-5-hexen-1-ol)
   b. An aluminum-containing residue comprising an elemental aluminum content in a quantity of 1.0 wt % of the hydroxyl-functionalized propylene-based copolymer.

A paving and roofing composite material having this specific composition at ±1 wt %:
a. A neat bitumen in a quantity of 85 wt %
b. A ground tire rubber in a quantity of 10 wt %
c. A hydroxyl-functionalized propylene-based copolymer viz. poly(propylene-co-1-hexene-co-5-hexen-1-ol in a quantity of 5 wt %
d. An aluminum-containing residue comprising an elemental aluminum content in a quantity of 0.99 wt % of the hydroxyl-functionalized propylene-based copolymer.

### EXAMPLES

Typical Preparation Procedure Of Isotactic poly(propylene-co-1-hexene-co-5-hexen-1-ol).

The polymerization experiment was carried out using a stainless steel BÜCHI reactor (2 L) filled with pentamethylheptane (PMH) solvent (1 L) using a stirring speed of 600 rpm. Catalyst and co-monomer solutions were prepared in a glove box under an inert dry nitrogen atmosphere. The reactor was first heated to 40° C. followed by the addition of TEA (1.0 M solution in toluene, 2 mL), 1-hexene (neat 10 mL), and triethylaluminum (TEA)-pacified 5-hexen-1-ol (1.0 M solution in toluene, TEA:5-hexen-1-ol=1:1, 10 mL). The reactor was charged at 40° C. with gaseous propylene (100 g) and the reactor was heated up to the desired polymerization temperature of 130° C. resulting in a partial propylene pressure of about 15 bar. Once the set temperature was reached, the polymerization reaction was initiated by the injection of the pre-activated catalyst precursor bis((2-oxoyl-3-(dibenzo-1H-pyrrole-1-yl)-5-(methyl)phenyl)-2-phenoxy)-2,4-pentanediylhafnium (IV) dimethyl [CAS 958665-18-4]; other name hafnium [[2′,2′″-[(1,3-dimethyl-1,3-propanediyl)bis(oxy-κO)]bis[3-(9H-carbazol-9-yl)-5-methyl[1,1′-biphenyl]-2-olato-κO]](2-)]dimethyl](Hf—O4, 2 μmol) in MAO (30 wt % solution in toluene, 11.2 mmol). The reaction was stopped by pouring the polymer solution into a container flask containing demineralized water/iPrOH (50 wt %, 1 L) and Irganox 1010 (1.0 M, 2 mmol). The resulting suspension was filtered and dried at 80° C. in a vacuum oven, prior the addition of Irganox 1010 as an antioxidant. The poly(propylene-co-1-hexene-co-5-hexen-1-ol) was obtained as an elastic transparent material.

Procedure of the Deashing of Isotactic poly(propylene-co-1-hexene-co-5-hexen-1-ol)

The copolymers obtained from the solution process may be deashed in order to remove trace of protective species. To do so, the copolymer (10 g) was dispersed in a mixture of dry toluene (400 ml) with concentrated (37%) HCl (10 ml, 0.13 mol, 4.74 g) and heated under reflux until the copolymer dissolved. Once the polymer was properly dissolved, methanol (250 ml) was added to the hot mixture and the mixture was heated under stirring at 70-80° C. for 1 additional hour. Then the polymer was precipitated in cold methanol, filtered and double washed with methanol. The resulting polymer was dried at 80° C. in a vacuum oven for 24 hours.

### Commercially Available Materials Utilized in the Experiments

Paving grade bitumen 70/100 (PG 58-22) from LOTOS Asfalt Sp. z o.o. (Poland) was used in the experiments as reference material and neat binder dedicated to further polymer modification processes through the wet method. Ground tire rubber powder (GTR, avg. particle size 0.0-0.8 mm) was purchased from Recykl Group S.A. (Poland) and used as received as raw material in the preparation of rubberized bitumen samples for further experiments incorporating synthesized hydroxyl-functionalized copolymers as compatibilizers between digested grains of GTR and bitumen components. Poly(styrene-co-butadiene-co-styrene) (SBS DST L 30-01) supplied by Sibur International GmbH (Austria) was used as received in the process of bitumen modification and rubberized bitumen compatibilization to obtain reference samples.

TABLE 1
Molecular characterization and thermal properties of non-deashed and
deashed isotactic poly(propylene-co-1-hexene-co-5-hexen-1-ol) copolymers
utilized in the process of rubberized bitumen compatibilization.

| | | | | | | | | | Alumina |
|---|---|---|---|---|---|---|---|---|---|
| Sample | Mₙ | M_{w} | Ð | Tₘ | ΔHₘ | T_{c} | χ | OH | content |
| name | [kg/mol] | [kg/mol] | [—] | [° C.] | [J/g] | [° C.] | [%] | [% mol] | [%] |
| FPO1 | 30.7 | 135.2 | 4.4 | 85.5 | 22.1 | 55.6 | 10.7 | 0.2 | 0.99 |
| FPO2 | 30.4 | 136.8 | 4.5 | 84.0 | 18.0 | 45.6 | 11.5 | 0.2 | 0.6 |
| FPO3 | 29.5 | 129.8 | 4.4 | 83.2 | 17.1 | 42.9 | 12.1 | 0.2 | 0.45 |
| FPO4 | 31.5 | 144.9 | 4.6 | 86.7 | 22.5 | 58.4 | 9.2 | 0.2 | 1.2 |
| FPO1(d) | 29.7 | 130.1 | 4.4 | 82.0 | 26.8 | 40.9 | 12.9 | 0.2 | 0.29 |
| FPO5 | 29.3 | 132.5 | 4.5 | 81.8 | 28.4 | 40.0 | 11.5 | 0.2 | 0.1 |
| FPO6 | 30.1 | 135.5 | 4.5 | 84.5 | 19.7 | 55.3 | 10.5 | 0.3 | 1.00 |
| CFPO1 | 27.5 | 128.4 | 4.6 | 81.0 | 26.3 | 39.7 | 10.5 | 0.2 | 0.05 |
| CFPO2 | 26.5 | 131.2 | 4.9 | 103.3 | 30.5 | 57.8 | 12.2 | 0.2 | 0.13 |
| CFPO3 | 28.2 | 129.5 | 4.6 | 58.2 | 20.1 | 24.3 | 7.6 | 0.2 | 0.18 |

χ was calculated assuming the heat of fusion of 100% crystalline iPP of 207 J/g

TABLE 2
Basic properties and composition of ground tire rubber powder
used in the experiments according to producer's data.

| | | | | |
|---|---|---|---|---|
| Entry | Property | Unit | Value | Test method |

Composition

| | | | | |
|---|---|---|---|---|
| 1 | Isoprene rubber, natural (NR) or synthetic | wt % | 53.4 | ISO 7270: 1994 |
| | (IR) rubber, butadiene-styrene rubber (SBR) | | | ISO 4650: 2005 |
| | | | | QPB.30/BLC |
| | | | | (TGA) |
| 2 | Acetone extract | wt % | 9.9 | |
| 3 | Total sulphur | wt % | 1.7 | PN-92/C-04219 |
| | | | | met. A |
| 4 | Organic excipients (non-polymeric) | wt % | 10.2 | QPB.30/BLC |
| 5 | Carbon black | wt % | 28.6 | (TGA) |
| 6 | Mineral content | wt % | 7.8 | |
| 7 | Ash (@550° C.) | wt % | 8.3 | PN-ISO |
| | | | | 247: 1996 |

Basic properties

| | | | | |
|---|---|---|---|---|
| 8 | Grain size distribution | mm | 0.0-0.8 | Internal |
| 9 | Bulk density | kg/m³ | 380-600 | EN 1097-3: 2000 |
| 10 | Volume density | kg/m³ | 1100-1250 | EN 1097-6: |
| | | | | 2002/A1: 2006 |
| 11 | Humidity | % | ≤0.75 | EN 1097-5: 2008 |
| 12 | Hardness | IRHD | 40-80 | ISO 48: |
| | | | | 1998/A1: 2000 |
| | | | | met. M |
| 13 | Dust content | % | ≤18.5 | ISO 247: 1996 |
| 14 | Sulphur content | % | 1-3 | PN-C- |
| | | | | 04244: 1975 |
| 15 | Extractable heavy metal content | mg/l | ≤0.03 | ICP-OES |
| 16 | Extractable zinc content | mg/l | ≤0.5 | EN 12457-1: |
| | | | | 2006 |
| 17 | Extractable PAH content | mg/l | — | HPLC-FD |
| 18 | Impurities traces content (textiles, metals, | % | ≤3 | Internal |
| | sand, wood, coloured rubber) | | | |

TABLE 3
Basic properties of styrene-butadiene copolymer
utilized in the process of bitumen modification.

| | | | | | | Tensile | |
|---|---|---|---|---|---|---|---|
| | | | | | | stress at | |
| | | | MFR | Tensile | Ultimate | 300% | |
| | | PS content | 190° C./5 kg | strength | elongation | elongation | Hardness; |
| name | Composition | [wt %] | [g/10 min] | [MPa] | [%] | [MPa] | Shore A |
| SBS | poly(styrene- | 30 ± 1.5 | <1 | ≥14.7 | ≥700 | ≥2.7 | 72 ± 5 |
| | co-butadiene- | | | | | | |
| | co-styrene) | | | | | | |

TABLE 4
Properties of neat bitumen and Polymer Modified Bitumen (PMB) samples.

| | | | | | | | | | | | | | QNM-AFM | |
|---|---|---|---|---|---|---|---|---|---|---|---|---|---|---|
| Composition | | | | Basic | | | Hot storage stability test results | | | | | | results | |
| | Type | | | properties | | | P_{avg.} | P_{avg.} | | SP_{avg.} | SP_{avg.} | | DMT | Adhesion |
| | of | Modifier | Bitumen | η₁₈₀ | P_{avg.} | SP_{avg.} | ₜₒₚ | _{bot} | Δ P | ₜₒₚ | _{bot} | ΔSP | modulus | force |
| Entry | modifier | [wt. %] | [wt. %] | [Pa · s] | [dmm] | [° C.] | [dmm] | [dmm] | [dmm] | [° C.] | [° C.] | [° C.] | [GPa] | [nN] |
| CE1n | Bitumen | 0 | 100 | 0.035 | 83 | 44.7 | 84 | 83 | 1 | 45.2 | 45.3 | 0.1 | 2.5 | 35 |
| | 70/100 | | | | | | | | | | | | | |
| CE2 | GTR | 10 | 90.0 | 0.156 | 55 | 55.6 | 62 | 74 | 12 | 49.4 | 58.3 | 8.9 | 1.9 | 44 |
| CE3 | GTR | 10 | 87.0 | 0.326 | 60 | 58.9 | 56 | 57 | 1 | 57.1 | 72.0 | 12.9 | 2.0 | 48.5 |
| | SBS | 3 | | | | | | | | | | | | |
| CE4 | GTR | 10 | 85 | 0.250 | 37 | 63.9 | 32 | 39 | 7 | 71.2 | 63.2 | 8.0 | 2.3 | 53 |
| | CFPO1 | 5 | | | | | | | | | | | | |
| CE5 | GTR | 10 | 85 | 0.360 | 33 | 66.1 | 24 | 45 | 21 | 76.3 | 66.2 | 10.1 | 2.4 | 49 |
| | CFPO2 | 5 | | | | | | | | | | | | |
| CE6 | GTR | 10 | 85 | 0.230 | 41 | 61.5 | 38 | 49 | 11 | 65.5 | 59.1 | 6.4 | 2.1 | 50 |
| | CFPO3 | 5 | | | | | | | | | | | | |
| 1 | GTR | 10 | 87.5 | 0.190 | 41 | 60.6 | 42 | 52 | 10 | 56.9 | 62.9 | 6.0 | 1.7 | 39.0 |
| | FPO1(d) | 2.5 | | | | | | | | | | | | |
| 2 | GTR | 10 | 85.0 | 0.260 | 35 | 64.2 | 36 | 37 | 1 | 68.4 | 69.2 | 0.8 | 0.7 | 49.0 |
| | FPO1(d) | 5 | | | | | | | | | | | | |
| 3 | GTR | 10 | 87.5 | 0.181 | 53 | 53.7 | 60 | 55 | 5 | 48.9 | 59.1 | 10.0 | 1.8 | 38.0 |
| | FPO1 | 2.5 | | | | | | | | | | | | |
| 4 | GTR | 10 | 85.0 | 0.345 | 36 | 64.9 | 41 | 41 | 0 | 64.0 | 63.7 | 0.3 | 2.2 | 49.0 |
| | FPO1 | 5 | | | | | | | | | | | | |
| 5* | GTR | 10 | 85.0 | 0.325 | 38 | 61.7 | 46 | 40 | 6 | 59.9 | 64.1 | 4.2 | 2.4 | 51.0 |
| | FPO1 | 5 | | | | | | | | | | | | |
| 6 | GTR | 10 | 85.0 | 0.290 | 36 | 64.5 | 38 | 37 | 1 | 68.0 | 67.3 | 0.7 | 0.7 | 49.0 |
| | FPO2 | 5 | | | | | | | | | | | | |
| 7 | GTR | 10 | 85.0 | 0.280 | 36 | 64.3 | 38 | 37 | 1 | 67.6 | 66.5 | 0.9 | 0.7 | 49.0 |
| | FPO3 | 5 | | | | | | | | | | | | |
| 8 | GTR | 10 | 85.0 | 0.345 | 37 | 65.4 | 42 | 42 | 0 | 64.9 | 65.0 | 0.1 | 0.9 | 48.0 |
| | FPO4 | 5 | | | | | | | | | | | | |
| 9 | GTR | 10 | 85.0 | 0.260 | 35 | 64.2 | 36 | 37 | 1 | 68.4 | 69.2 | 10.8 | 0.7 | 49.0 |
| | FPO5 | 5 | | | | | | | | | | | | |
| 10 | GTR | 10 | 85.0 | 0.340 | 34 | 65.0 | 35 | 35 | 0 | 66.0 | 66.1 | 0.1 | 2.3 | 53 |
| | FPO6 | 5 | | | | | | | | | | | | |

η₁₈₀—dynamic viscosity at 180° C.
P_{avg.}—average penetration value
P_{avg. top}, P_{avg. bot}, ΔP—average penetration value after thermal stability test and the corresponding difference, respectively
S_{avg.}—average softening point
S_{avg. top}, S_{avg. bot}, ΔS—average softening point after thermal stability test and the corresponding difference, respectively
*obtained via Terminal Blend (TB) process

TABLE 5
Selected MSCR results for the obtained samples.

| | Test temperature | J_{nr, 3.2 kPa} | J_{nr, diff} | R_{3.2 kPa} | PG+ |
|---|---|---|---|---|---|
| Entry | [° C.] | [kPa⁻¹] | [%] | [%] | [—] |
| CE1 | 64 | 7.6 | 11.5 | 0.0 | failed |
| CE2 | 64 | 1.3 | 88.2 | 12.8 | failed |
| CE3 | 64 | 0.3 | 71.5 | 34.6 | V |
| CE4 | 64 | 0.3 | 82.5 | 27.9 | failed |
| CE5 | 64 | 0.2 | 90.3 | 23.4 | failed |
| CE6 | 64 | 0.3 | 85.5 | 24.4 | failed |
| 1 | 64 | 0.5 | 51.3 | 21.9 | V |
| 2 | 64 | 0.3 | 63.4 | 28.5 | E |
| 3 | 64 | 0.5 | 65.7 | 21.9 | V |
| 4 | 64 | 0.3 | 72.7 | 30.0 | E |
| 5 | 64 | 0.4 | 53.3 | 25.7 | E |
| 6 | 64 | 0.3 | 64.2 | 23.9 | E |
| 7 | 64 | 0.3 | 66.8 | 22.8 | E |
| 8 | 64 | 0.4 | 70.4 | 32.5 | E |
| 9 | 64 | 0.3 | 59.4 | 21.0 | E |
| 10 | 64 | 0.3 | 67.1 | 23.0 | E |

J_{nr, 3.2 kPa}—non-recoverable creep compliance at 3.2 kPa loading
J_{nr, diff}—difference between non-recoverable creep compliance values at 3.2 kPa and 1.0 kPa, respectively
R_{3.2 kPa}—percent recovery at 3.2 kPa loading
PG+—high-temperature limit of Performance Grade+ notification system acc. AASHTO M332
δ—phase shift angle
|G*|/sin(δ)—rutting factor

Failed—according to the standard, it means that that the given composition does not meet the requirements at indicated maximum application temperature, but still could be used at a temperature grade below. CE examples might of course fail at the tested temperature points, as they do not reveal sufficient mechanical properties without modifiers/compatibilizer (FPO)

TABLE 6
Performance grading of the tested samples
according to ASTM D7643 and AASHTO M320.

| Entry | Continuous PG [° C.] | Real PG [—] |
|---|---|---|
| CE1 | 62.7 | 58 |
| CE2 | 72.7 | 70 |
| CE3 | 84.9 | 82 |
| CE4 | 90.4 | 88 |
| CE5 | 94.4 | 94 |
| CE6 | 87.4 | 82 |
| 1 | 87.2 | 82 |
| 2 | 91.2 | 88 |
| 3 | 87.6 | 82 |
| 4 | 91.3 | 88 |
| 5 | 85.0 | 82 |
| 6 | 89.1 | 88 |
| 7 | 88.2 | 88 |
| 8 | 92.9 | 88 |
| 9 | 85.2 | 82 |
| 10 | 89.0 | 88 |

### Results

From the above, inventors found out that the hydroxyl-functionalized propylene-based copolymer need to have a minimal content of 1.00 Alumina content [%] and a melting temperature within the range of 60 to 100° C. (CFPO1-3), in order to achieve the invention.

It can be seen from Table 4, that the addition of the hydroxyl-functionalized propylene-based copolymer with or without a limited amount of aluminum-containing residue (i.e. FPO1-6, FPO1(d)) into rubber-modified bitumen composition when compared to the neat bitumen CE1 and GTR-modified bitumen CE2:
Substantially increase the dynamic viscosity, which will not hamper standard mixing and pumping procedures of the composition either added at 2.5 wt % or 5 wt % concentration
Provide sufficient hot-storage stability, given that the compatibilizer is added in a quantity higher than 2.5 wt %, more preferably higher than 3.5 wt %, which is beneficial for preventing phase separation of the ground tire rubber particles from a composition during storage and transportation at high operating temperatures
   When it is compared to rubber-modified bitumen compatibilized by SBS copolymer (CE3), the performance is even better in terms of basic properties and storage stability improvement when the hydroxyl-functionalized propylene-based copolymer is added in a quantity of 2.5 wt %, more preferably 5 wt %.

It can be seen from Table 5, that the addition of the hydroxyl-functionalized propylene-based copolymer with or without a limited amount of an aluminum-containing residue into rubber-modified bitumen composition when compared to the neat bitumen CE1 and GTR-modified bitumen CE2:
Decreases J_{nr, 3.2 kPa} value and increases PG+ grade, which promotes application of the composition in the pavements exposed to the very heavy (2.5 wt % of the compatibilizer) and extremely high traffic loads (5 wt % of the compatibilizer) only if its 7-day average maximum temperature does not exceed 64° C.
Provides sufficient J_{nr, diff} values at the given temperature conditions of MSCR testing, which beneficial for maintaining appropriate shear-stress resistance of a pavement except if composition comprises 5 wt % of the compatibilizer.
Increases R_{3.2 kPa} values at both test temperatures, which is advantageous in enhancing elasticity of the neat bitumen
   When it is compared to rubber-modified bitumen compatibilized by SBS copolymer (CE3), the performance is comparable at both test temperatures when the hydroxyl-functionalized propylene-based copolymers are added in a quantity of 2.5 wt %, except for slightly lower R_{3.2 kPa} values. The discrepancies in the elasticity are diminished if higher amounts of the hydroxyl-functionalized propylene-based copolymers are incorporated, which also results in lower J_{nr, 3.2 kPa} values, and thus, rutting resistance.

It can be seen from Table 6, that the addition of the hydroxyl-functionalized propylene-based copolymer with or without a limited amount of an aluminum-containing residue into rubber-modified bitumen composition when compared to the neat bitumen CE1 and GTR-modified bitumen CE2:
Increases Continuous PG and Real PG, which enables application of the composition comprising 2.5 wt % and 5 wt % of the compatibilizer in the areas of the world with prevailing hot-climatic conditions by extending pavement's high-temperature PG limit either to 82 or 88, respectively
   When it is compared to rubber-modified bitumen compatibilized by SBS copolymer (CE3), the performance is comparable when the hydroxyl-functionalized propylene-based copolymers are added in a quantity of 2.5 wt %. If higher amounts of the hydroxyl-functionalized propylene-based copolymers are incorporated, Real PG of the samples promotes by one grade when compared to CE3.

Examples 1 and 3 having a Δ Softening point (ΔSP)>5° C. but <=10° C., respectively 6 and 10° C. will not be suitable for road application but will be for roofing as reaching a Δ Softening point (ΔSP)<=5° C. is a standard requirement for road application.

The other examples according to the invention fulfil all requirements for road and Roofing application.

By comparing example 4 and 5, it can be conclude that the terminal blend (TB) process does not allow to reach the Continuous PG>=85° C. However using by using standard wet process at 180° C., this feature can be reach. Inventors believe that using a TB process which go above 200° C. that degrade a part of the components within the mixture. Therefore a material according to the invention made through a standard wet process at 180° C. is preferable for roofing and road application.

### Typical Procedure for Differential Scanning Calorimetry (DSC) Analysis.

Thermal properties of the polymer modifiers were analyzed by DSC using a DSC Q100 (TA Instruments, New Castle, DE, USA, UK). Thermograms were recorded for specimens heated in N₂ atmosphere during heating and cooling at a rate of 10° C./min. from −100° C. to 200° C. After the first heating, the specimens were kept in 200° C. for 3 min and then cooled down to ensure the same thermal history. The phase transitions were studied during cooling and the second heating. The crystallinity degree (χ) for specimens were calculated according to the following formula:

$$χ = \frac{Δ {H}_{m}}{αΔ {H}_{m}^{0}} \cdot 100 \%$$

where ΔHₘ is the enthalpy of melting, a and ΔHₘ⁰ is the weight fraction of PP and melting enthalpy of 100% crystalline PP, respectively, the value of ΔHₘ⁰=207 J/g has been assumed.

### Typical Procedure for Size Exclusion Chromatography (SEC) Analysis.

The molar masses (Mₙ and M_{w}) of bitumen modifiers were determined by high temperature size exclusion chromatography (HT-SEC) at 150° C. using a Polymer Char GPC-IR built around an Agilent GC oven model 7890 (Polymer Char, Valencia, ES) equipped with an autosampler and the Integrated Refractive Index Detector IR4. 1,2-dichlorobenzene (o-DCB) was used as an eluent at a flow rate of 1 mL/min.

### Typical Procedure for 1H Nuclear Magnetic Resonance (¹H NMR) Analysis.

¹H NMR analysis was carried out in deuterated tetrachloroethane (TCE-D2) at 130° C. using a Varian Mercury spectrometer (Bruker Company, Billerica, MA, USA) operating at 400 MHz. Traces of tetramethylsilane were used as internal standard.

### Inductively Coupled Plasma Mass Spectrometry (ICP-MS) Analysis.

Residual elemental aluminum content [%] in the functionalized polyolefins was established by ICP-MS. Approximately 150 mg of each sample was digested in 6 mL concentrated nitric acid (trace metal grade) by microwave assisted acid digestion using an Anton Paar Multiwave PRO equipped with closed high pressure Quartz digestion vessels. After the microwave digestion run, the acid was analytically transferred into a pre-cleaned plastic centrifuge tube containing 1 mL of internal standard solution and is diluted with MilliQ water up to the 50 mL mark. The elements in the sample are quantified using a multi-element calibration set from Inorganic Ventures using an Agilent 8900 ICP-MS system.

### Typical Procedure for the Wet Method of Bitumen Modification.

The modification of bitumen incorporating GTR as a modifier was carried out at 180° C. using Ultra-Turrax T50 basic homogenizer (IKA Company, Warsaw, Poland) equipped with S 50N-G 45 M dispersing tool working at the speed of 4000 rpm for 60 minutes. The resultant rubberized bitumen samples were subsequently compatibilized with the disclosed polymers (SBS, FPO, or FPO(d)) at 180° C. using the same equipment and shear rate for 120 minutes.

### Typical Procedure for the Terminal Blend Method of Bitumen Modification.

The terminal blend process was carried out using GTR as a modifier at 240° C. using Ultra-Turrax T50 basic homogenizer (IKA Company, Warsaw, Poland) equipped with S 50N-G 45 M dispersing tool working at the speed of 4000 rpm for 60 minutes. The resultant rubberized bitumen samples were subsequently compatibilized with the disclosed compatibilizer (FPO) at 180° C. using the same equipment and shear rate for 120 minutes.

### Typical Procedure for Penetration Analysis.

Penetration measurements were performed according to EN 1426. In this method, a needle with specified dimension and weight is penetrating the asphalt sample, under 100 g load for 5 seconds at 25° C. The penetration value is expressed in decimillimetres (dmm) as a vertical distance penetrated by a needle into a bitumen's bulk. Final value for a given specimen is derived as the average from three individual measurements.

### Typical Procedure for Softening Point Analysis.

Softening point tests were performed with Ring&Ball apparatus according to EN 1427. In this method two metal rings filled with a bitumen sample are heated at a controlled rate of 5° C./min in a water bath while each ring supports a standardized steel ball. The softening point is determined as the temperature at which steel balls coated with bitumen film fall through a height of 25 mm. The reported softening point (SP) value is the average of the temperatures determined for each ball.

### Typical Procedure for the Dynamic Viscosity Analysis.

The dynamic viscosity test was performed at 180° C. using a Haake Viscotester 2 Plus (TermoElectron, Waltham, MA, USA) according to EN 13302 standard. The test was performed by immersing the appropriate cylindrical measuring head of the viscometer in the bitumen's bulk to a depth determined by the scale placed above the spindle. Eventually, the dynamic viscosity value [dPa·s] was read from the digital display of the apparatus.

### Typical Procedure for the Hot-Storage Stability Analysis.

The hot-storage stability tests were performed according to EN 13399. In this method, two sealed aluminum tubes (200 mm×40 mm) are filled with liquid bitumen and placed vertically in an oven at 180° C. for 72 h. In the next step, the tubes are cooled down to the room temperature and stored at 5° C. for at least 24 h. Subsequently, the aluminum cover is removed manually and the sample is divided into 3 sections: top, middle and bottom, respectively. The top and bottom sections are molten separately and used for penetration and softening point analysis, whilst the middle part is discarded.

### Rheological Analysis Using Dynamic Shear Rheometer (DSR).

Rheological tests (DSR analysis) were performed using modular compact rheometer Physica MCR301 (Anton Paar) in oscillatory shear mode on unaged binder's specimens. Prior to the test, each sample was conditioned at 20° C. for at least 20 minutes. Temperature sweep tests in oscillatory shear were conducted at a frequency of 10 rad/s, at strain 1%, using plate geometry with 25 mm diameter and a gap size of 1 mm, in the temperature range of 30-120° C. As a result of DSR tests, obtained rheological indices were the dynamic shear modulus and its components (G′, G″, |G*|), phase angle (δ), loss factor (tan(δ)) as well as the rutting factor (|G*|/sin(δ)). The latter parameter was incorporated to evaluate the rutting resistance of a modified bitumen and determining the high temperature continuous performance grades (Continuous PG) and real performance grades (Real PG) of the tested samples according to ASTM D7643 and AASHTO M320, respectively.

Multiple Stress Creep Recovery Test (MSCR) was performed in accordance to AASHTO M350-20 on RTFOT aged bitumen samples (AASHTO T240). The test temperatures (64° C., 70° C.) were selected in line with AASHTO M350-20 specifications with respect to the prevailing climatic conditions at potential application areas of modified binders. Furthermore, the reference samples (Table 4, Entry CE1-CE3) were decided to be additionally tested at 58° C., as they did not pass the requirements at initially appointed test conditions. The essence of this method is to forecast a binder's resistance to the accumulation of permanent deformation (rutting), as well as to evaluate the effectiveness of bitumen modification by assessing the presence of elastomeric network within a tested bitumen sample due to the application of loading values above its linear visco-elastic region (LVE). The following mechanisms are examined during the MSCR test: binder's creep properties, when stress is applied at specific value for 1 s, subsequently accompanied by elastic recovery of a material during 9 s of relaxation period, after removal of an applied stress. The measurement is performed separately at 10 loading cycles at stress values of 0.1 kPa and 3.2 kPa, respectively. Two essential parameters are obtained for both levels of the applied stress, i.e. non-recoverable creep compliance (Jₙᵣ, kPa⁻¹) and the percentage recovery (R, %). Jₙᵣ value at the stress of 3.2 kPa (J_{nr, 3.2 kPa}) is of key importance, as it is the measure of a binder's resistance to deformation. The lower J_{nr, 3.2 kPa} value indicates the enhanced rutting resistance of a tested bitumen sample. On the other hand, the higher values of the percentage recovery at 3.2 kPa (R_{3.2 kPa}) prove the effectiveness of a binder's modification by assessment of the presence of elastomeric network within a bitumen's bulk. In line with AASHTO standard, the percentage difference between J_{nr, 3.2 kPa} and J_{nr, 0.1 kPa} values (J_{nr, diff}, %) must not be higher than 75% for a tested binder, as it could indicate high shear susceptibility of the material, and thus the determination of high temperature PG+ range would be inaccurate in respect to real conditions at the potential construction site. MSCR testing of the disclosed PMB samples enabled to explore the high temperature PG limits of the particular compositions within Performance Grade Plus (PG+) system, in accordance to AASHTO M332 specifications.

### Fluorescence and Optical Microscopy.

Fluorescence and optical imaging was directly performed using DeltaOptical 800 M microscope with UV light source on the bitumen sample prepared for AFM analysis without further treatment at ambient conditions with 20× magnification. For fluorescence microscopy imaging, the exposure time range of 300-1000 ms was used.

### AFM Ha-QNM Experimental.

Samples were also characterized by HA-QNM mode with a frequency of 0.5 Hz using an AFM tip with a spring constant of 5 N/m (TAP-150-30, No. 3 k=5 N/m) at ambient conditions. With this special tip all the information of the tip needed for the QNM mode can be transferred immediately to the AFM operation program by a click with a bar-reader. Therefore, no calibration steps for spring constant and tip radius are needed before real measurements. QNM mode enables the quantitative measurements of nano-scale material mechanical properties by performing pixel wise force curves in the scanned area. Analysis of the individual force curve data by the AFM Nano-scope software provides a map of material properties with the same resolution of topography image. Here the elastic modulus of the scanned surface was extracted from the force curve using the Derjaguin-Muller-Toropov model and presented in the modulus mapping images.

1. A composite material for paving and roofing application, comprising
sulfur-vulcanized rubber, between 5 to 20 wt % of the composite material,
neat bitumen between 70 to 93 wt % of the composite material,
compatibilizer between 2 to 10 wt % of the composite material, and
comprising
a. a hydroxyl-functionalized propylene-based copolymer having a melting temperature Tm below 100° C., or that is atactic or syndiotactic, and.
b. an aluminum-containing residue comprising an elemental aluminum content from a quantity of at least 0.1 wt % of the hydroxyl-functionalized propylene-based copolymer.

2. The composite material according to claim 1, wherein sulfur-vulcanized rubber is ground tire rubber.

3. The composite material according to claim 1, wherein the hydroxyl-functionalized propylene-based copolymers is a polymer comprising propylene, optionally a second olefin monomer and a hydroxyl-functionalized olefin.

4. The composite material according to claim 1, wherein the hydroxyl-functionalized propylene-based copolymers is either amorphous or semi-crystalline.

5. The composite material according to claim 1, wherein the hydroxyl-functionalized propylene-based copolymers is selected from the list comprising poly(propylene-co-5-hexen-1-ol), poly(propylene-co-10-undecen-1-ol), poly(propylene-co-ethylene-co-5-hexen-1-ol), poly(propylene-co-ethylene-co-10-undecen-1-ol), poly(propylene-co-1-hexene-co-5-hexen-1-ol), poly(propylene-co-1-hexene-co-10-undecen-1-ol), poly(propylene-co-1-octene-co-5-hexen-1-ol), poly(propylene-co-1-octene-co-10-undecen-1-ol).

6. The composite material according to claim 1, wherein the compatibilizer comprises poly(propylene-co-1-hexene-co-5-hexen-1-ol) and an aluminum-containing residue comprising an elemental aluminum content in a quantity 0.8 to 1.2 wt % of the hydroxyl-functionalized propylene-based copolymer.

7. The composite material according to claim 1, wherein the hydroxyl-functionalized propylene-based copolymers is made in a solution polymerization process.

8. The composite material according to claim 1, wherein the composition has at least all of the following:
Dynamic viscosity (η180) at 180° C. not higher than 0.345 Pa·s according to EN 13302.
Avg. Penetration (Pavg.)<54 dmm according to EN 1426, and
Avg. Softening point (SPavg.)>53° C. according to EN 1427, and
Δ Penetration (ΔP)<=10 dmm, according to EN 13399, and
Δ Softening point (ΔSP)<=10° C., according to EN 13399, and
Performance Grade Plus (PG+) grade at 64° C. of V or E according to AASHTO M332-20.

9. The composite material according to claim 1, wherein the composition has at least all of the following:
Non-recoverable creep compliance J_{nr, 3.2 kPa}<1 measured at 64° C., and
J_{nr, diff} at 64° C.<75% according to AASHTO M332-20, and
R_{3.2 kPa} at 64° C.>21% according to AASHTO M332-20

10. The composite material according to claim 1, wherein the composition has at least all the followings:
Continuous PG>=85° C. according to ASTM D7643, and
Real PG>=82 according to AASHTO M320.

11. A process for making the composite material according to claim 1, wherein the mixing of the neat bitumen with the sulfur-vulcanized rubber has been done under a wet process, at temperature range of 160 to 240° C., under constant agitation of the mixture.

12. A process for making composite material according to claim 1, wherein the mixing of the neat bitumen with the sulfur-vulcanized rubber has been done under a terminal blend process, at temperature range of 230 to 260° C., under constant agitation of the mixture.

13. The process according to claim 11, wherein the compatibilizer is added to mix of neat bitumen and sulfur-vulcanized rubber and the resulting rubber-modified bitumen mixture is stirred for additional time from 1 to 6 h, under constant agitation, and maintaining a constant temperature in the range of 160-200° C.

14. The process according to claim 11, wherein it is performed under an inert atmosphere to hinder the thermal degradation of the compatibilizer.

15. The composite material according to claim 8, wherein Δ Softening point (ΔSP)<=5° C.
